(19) United States
(12) Patent Application Publication
(10) Pub. No.: US 2016/0086105 A1
(43) Pub. Date: Mar. 24, 2016

(54) INFORMATION PROCESSING DEVICE, INFORMATION PROCESSING METHOD AND NON-TRANSITORY COMPUTER READABLE STORAGE MEDIUM

(71) Applicant: YAHOO JAPAN CORPORATION, Tokyo (JP)

(72) Inventor: Takamitsu IRIYAMA, Tokyo (JP)

(21) Appl. No.: 14/848,495

(22) Filed: Sep. 9, 2015

(30) Foreign Application Priority Data
Sep. 19, 2014 (JP) 2014-190891

(51) Int. Cl. G06Q 10/02; G06Q 50/12

(52) U.S. Cl. CPC G06Q 10/02; G06Q 50/12

(57) ABSTRACT

A storage unit configured to store shop information regarding a predetermined item for each shop, an extracting unit (control unit) configured to extract a recommended shop satisfying a predetermined approximation condition based on the shop information of a selected shop selected by a user and the shop information of a shop other than the selected shop stored in the storage unit, and a recommending unit (control unit) configured to recommend the recommended shop extracted by the extracting unit to the user are provided.

### CROSS-REFERENCE TO RELATED APPLICATION(S)

The present application claims priority to and incorporates by reference the entire contents of Japanese Patent Application No. 2014-190891 filed in Japan on Sep. 19, 2014.

### BACKGROUND OF THE INVENTION

1. Field of the Invention

The present invention relates to an information processing device, an information processing method, and a program.

2. Description of the Related Art

A method of extracting a shop meeting a user's wish by specifying a search condition and transmitting shop information including available seat information and the like of the extracted shop to a portable terminal of the user when the user searches for a shop such as a restaurant on the Internet is conventionally known (for example, Japanese Patent Application Laid-open No. 2014-067261).

However, when pieces of shop information of a plurality of shops are transmitted, if the shop selected by the user out of them is fully occupied, the user is required to select again from a plurality of pieces of shop information. In this case, if there is no other shop which the user prefers, the user should search after newly specifying the search condition, and this is complicated.

User's preferences are varied and it takes time to set the search condition such that all the conditions desired by the user are satisfied. Furthermore, the desired condition of the user is often unclear at the time of search, so that it often takes time to search while changing the search condition little by little to find out a candidate shop.

### SUMMARY OF THE INVENTION

It is an object of the present invention to at least partially solve the problems in the conventional technology.

According to one aspect of an embodiment, an information processing device includes a storage unit configured to store shop information regarding a predetermined item for each shop, an extracting unit configured to extract a recommended shop satisfying a predetermined approximation condition based on the shop information of a selected shop selected by a user and the shop information of a shop other than the selected shop stored in the storage unit and a recommending unit configured to recommend the recommended shop extracted by the extracting unit to the user.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a schematic configuration of an information processing system according to this embodiment;

FIG. 2 is a schematic diagram illustrating a screen of a shop information page of a selected shop;

FIG. 3 is a schematic diagram illustrating a screen on which a recommended shop for the selected shop is displayed;

FIG. 4 is a schematic diagram illustrating a screen on which the recommended shop for a second selected shop is displayed;

FIG. 5 is a flowchart of an information distributing process; and

FIG. 6 is a schematic diagram illustrating a screen of a shop information page of a selected shop of another embodiment.

### DETAILED DESCRIPTION OF THE PREFERRED EMBODIMENTS

An embodiment is hereinafter described with reference to the drawings. The following being an example of the embodiment does not limit the embodiment.

Meanwhile, searching for a shop on a search site on the Internet is hereinafter described as an example; the “shop” in a broad sense includes a facility and transportation providing goods or services, and searching for a shop includes searching for an available room of accommodation and searching for an available seat on the transportation such as a railroad and a bus, for example.

### 1. Outline of Information Processing System

An information processing system 1 according to this embodiment is configured to, when a user receives pieces of shop information of a plurality of shops while specifying a search condition and a shop which the user selects out of them (hereinafter, referred to as a “selected shop”) is fully occupied, recommend a shop similar to the selected shop as a recommended shop on the search site for searching for a restaurant on the Internet.

### 2. Configuration of Information Processing System

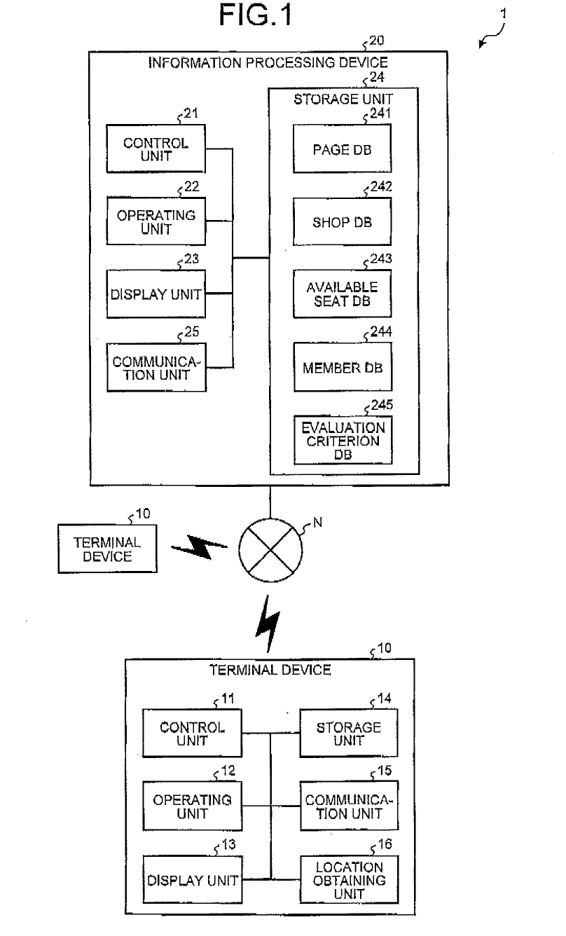

The information processing system. 1 is provided with a terminal device 10 and an information processing device 20 as illustrated in FIG. 1. The terminal device 10 connected to the information processing device 20 through a communication network N may receive a web page from the information processing device 20 to screen-display the web page on the search site for searching for a restaurant.

2-1. Terminal Device

The terminal device 10 being a user terminal for browsing the web page is provided with a control unit 11, an operating unit 12, a display unit 13, a storage unit 14, a communication unit 15, a location obtaining unit 16 and the like as illustrated in FIG. 1.

Specifically, the terminal device 10 is formed of information processing equipment such as a personal computer, a notebook computer, a tablet computer, a mobile terminal such as a smartphone or the like, for example, and is provided with a web browser (web content browsing software).

The control unit 11 is provided with a CPU (central processing unit), a ROM (read only memory), a RAM (random access memory) and the like and integrally controls each unit of the terminal device 10 by cooperation of the ROM developed in a working area of the RAM, program data stored in the storage unit 14, and the CPU.

The operating unit 12 provided with a touch panel, a keyboard including character input keys, number input keys, and other keys associated with various functions, and a pointing device such as a mouse, for example, receives an operation input from the user to output an operation signal corresponding to the operation input to the control unit 11.

The display unit 13 provided with a display such as a CRT (cathode ray tube) and an LCD (liquid crystal display), for example, displays an image based on a display control signal output from the control unit 11 on a display screen.

The storage unit 14 formed of a HDD (hard disk drive), a semiconductor memory and the like, for example, stores the program data and various data so as to be readable/writable by the control unit 11.

The communication unit 15 being a communication interface including a communication IC (integrated circuit), a communication connector and the like performs data communication through the communication network N by using a predetermined communication protocol under control of the control unit 11.

The location obtaining unit 16 is provided with a GPS module, an autonomous navigation unit and the like. The GPS module is provided with a GPS antenna and the like. The GPS antenna receives GPS signals transmitted from a plurality of GPS satellites launched into low-earth orbit. The GPS antenna receives the G?S signals transmitted from at least three GPS satellites, detects an absolute current location (latitude/longitude) of the terminal device 10 based on the received GPS signals, and outputs detected location information to the control unit 11, as reference location information.

2-2. Information Processing Device

The information processing device 20 is provided with a control unit 21, an operating unit 22, a display unit 23, a storage unit 24, a communication unit 25 and the like, for example, as illustrated in FIG. 1.

The control unit 21 provided with a CPU, a ROM, a RAM and the like integrally controls each unit of the information processing device 20 by cooperation of the ROM developed in a working area of the RAM, program data stored in the storage unit 24, and the CPU.

The control unit 21 has a function as a shop extracting unit; when this receives a request to “search for a similar shop” from the user when the selected shop selected by the user is fully occupied on the restaurant search site on the Internet, this calculates an approximation degree of a predetermined compared element based on the shop information of the selected shop and pieces of stop information of other shops stored in a shop DB 242 to extract the recommended shops with a high approximation degree.

The compared elements specifically include (1) distance from selected shop, (2) price range, (3) food category, (4) shop name, (5) area of food category, (6) hinds of dishes to be offered, and (7) shop customer layer; the approximation degree thereof is calculated based on an evaluation criterion DB 245 from items of the shop information of the selected shop and the pieces of shop information of other shops stored in the shop DB 242.

The control unit 21 has a function as a recommending unit and recommends the predetermined number of (for example, two) shops in descending order of approximation degree out of the recommended shops extracted by the extracting unit to the user.

The operating unit 22 provided with a keyboard including character input keys, number input keys, and other keys associated with various functions, a pointing device such as a mouse and the like, for example, receives an operation input from the user to output an operation signal corresponding to the operation input to the control unit 21.

The display unit 23 provided with a display such as a CRT and an LCD, for example, displays an image based on a display control signal output from the control unit 21 on a display screen.

The storage unit 24 formed of a HDD, a semiconductor memory and the like, for example, stores data such as the program data for displaying the web page such as text information of the web page and various setting data so as to be readable/writable by the control unit 21.

A page DB 241 stores the text information of the web page and required information is read therefrom in response to a web page obtaining request from the terminal device 10.

The shop DB 242 stores the shop information regarding predetermined items such as a shop ID, a shop location (latitude/longitude), the price range, the food category, the shop name, a location of the area of food category (latitude/longitude), the kinds of dishes to be offered, and the shop customer layer for each shop.

An available seat DB 243 stores available seat information of the shop; this stores an available seat status such as the number of available seats in an appropriate manner.

A member DB 244 stores user-information such as birth date, sex, address, and occupation of a member user who utilizes the search site for searching for a restaurant in association with a user ID. Trend in age, sex, address, occupation and the like of the customer layer using the shop is analyzed from the user IDs of the users who post comments to the shop in a shop page in which the shop information is displayed, and the information of the shop customer layer is registered in the shop DB 242.

A parameter for calculating the approximation degree of the compared element is registered in the evaluation criterion DB 245. Specifically, the parameter serving as an evaluation criterion is stored such as five points, three points, and one point if the distance from the selected shop is not longer than 10 m, 200 m, and 300 m, respectively, when the approximation degree of the distance from the shop is calculated, for example.

The communication unit 25 being a communication interface including a communication IC, a communication connector and the like performs the data communication through the communication network N by using a predetermined communication protocol under control of the control unit 21.

### 3. Calculation of Approximation Degree

In this embodiment, in a case in which the selected shop selected by the user is fully occupied when the user searches for a restaurant, if the request from the user to “search for a shop similar to” the selected shop is received, the approximation degree is calculated between the selected shop and other shops stored in the shop DB 242 and the shop with the high approximation degree is extracted as the recommended shop.

Specifically, the approximation degree is calculated by setting values of seven compared elements of (1) distance from selected shop, (2) price range, (3) food category, (4) shop name, (5) area of food category, (6) kinds of dishes to be offered, and (7) shop customer layer as seven-dimensional vector elements and calculating a sum of the vectors. Then, each compared element is weighted and a distance between the vectors is calculated to evaluate the approximation degree.

That is to say, the approximation degree is calculated according to user's preference not by calculating the approximation degrees of (1) to (7) and simply summing them but by adjusting them such that the compared element on which the user places importance contributes more to the approximation degree.

It is weighted according to a condition initially specified by the user on the search site, for example. Specifically, when the user searches while selecting only the price range on the search site, it is weighted such that a score of the approximation degree of the price range doubles to calculate the approximation degree.

A method of calculating the approximation degree of each compared element is hereinafter described.

3-1. Compared Element (Distance from Selected Shop)

The approximation degree of (1) distance from selected shop is calculated by calculating a straight distance between the shops based on the latitude/longitude information of the selected shop stored in the shop DB 242 and the latitude/longitude information of other shops stored in the shop DB 242 and using the parameter for scoring difference in distance stored in the evaluation criterion DB 243.

Specifically, the approximation degree is calculated such that the score becomes higher as it is closer to the selected shop; for example, five points, three points, and one point if the distance from the selected shop is not longer than 100 m, 200 m, and 300 m, respectively.

Meanwhile, when a current location of the user may be obtained from the location obtaining unit 16 of the terminal device 10, a distance from the current location of the user may also be included in the calculation. Specifically, as for the shop 100 m from the selected shop, a point is added if the shop is located closer to the location of the user than the selected shop, and the point is subtracted if the shop is located farther from the location of the user than the selected shop.

3-2. Compared Element (Price Range)

The approximation degree of (2) price range is calculated by the price range for each shop stored in the shop DB 242 and the parameter for scoring difference in price range stored in the evaluation criterion DB 245.

An average budget of the customers of the shop is stored in the shop DB 242 as the price range, for example, and the approximation degree is calculated by comparing the price range of the selected shop and the price range of other shops stored in the shop DB 242.

Specifically, the approximation degree is calculated such that the Score becomes higher as the price range is closer to that of the selected shop; for example, five points, three points, and one point when the difference is within 500 yen, 1,000 yen, and 2,000 yen, respectively.

3-3. Compared Element (Food Category)

The approximation degree of (3) food category is calculated by the food category for each shop stored in the shop DB 242 and the parameter for scoring difference in food category stored in the evaluation criterion DB 245.

In the evaluation criterion DB 245, the food category is stored in a hierarchical structure such as “Japanese food>noodle>udon” for “udon”, “Japanese food>noodle>soba” for “sobs”, “Japanese food>kaiseki dishes” for “kaiseki dishes”, and “Western foci>Spanish food” for “Spanish food”, for example.

The approximation degree is calculated such that the score becomes higher as types of foods belong to closer classes; specifically, five points when the food category of the selected shop and that of another shop stored in the shop DE is completely the same, three points when the difference is that of small classification such as between “udon” and “soba” and one point when the difference is that of middle classification such as between “udon” and “kaiseki-dishes” even when the categories are not the same, and no point when the difference is that of large classification such as between “Japanese food” and “Western food”.

Meanwhile, it is not simply scored in terms of classes; if many users do not strictly separate Szechuan food from Beijing food in Chinese food, it is also possible to calculate such that the approximation degree becomes higher even when the classes are different.

3-4. Compared Element (Shop Name)

Next, calculation of the approximation degree of (4) shop name is described. The approximation degree of the shop name is calculated by the shop name for each shop stored in the shop DB 242 and the parameter for scoring difference in shop name stored in the evaluation criterion DB 245.

Specifically, the approximation degree is calculated by comparing a character type and word meaning of the shop name between the selected shop and other shops stored in the shop DB. The point is added such that the approximation degree becomes higher; for example, three points are added if the same character type among alphabet, hiragana, Chinese character or the like is used, for example.

If a foreign language is used as the shop name, the meaning thereof in Japanese is also stored in the shop DB 242 and the meanings thereof in Japanese are compared to each other. The point is added such that the approximation degree becomes higher; three points are added when the meanings are the same.

Meanwhile, the character type may be further classified; Chinese may be classified into simplified Chinese and traditional Chinese, for example, and one point may be added if character classification is the same.

3-5. Compared Element (Area of Food Category)

(5) Area of food category is calculated by location information of the area of the food category stored in the shop DB 242 and the parameter for scoring the area of the food category stored in the evaluation criterion DB 245.

The shop DB 242 stores a country to which the food category such as Thai food, Vietnamese food, and Turkish food belongs, and latitude/longitude information of the country based on the barycenter of the territory and other medians, the capital city and the like as the location information.

The approximation degree is calculated by calculating a straight distance between the location information of the area of the food category of the selected shop and that of the other shops stored in the shop DB 242 to score according to the distance between the areas of the food category.

Specifically, it is calculated such that the score becomes higher as the distance between the areas of the food category is shorter; for example, five points, three points, and one point when the distance between the areas of the food category is not longer than 100 km, 500 km, and 1,000 km, respectively.

3-6. Compared Element (Kinds of Dishes to be Offered)

The approximation degree of (6) kinds of dishes to be offered is calculated by the kinds of dishes for each shop stored in the shop DO 242 and the parameter for scoring the kinds of dishes stored in the evaluation criterion DB 245.

Specifically, it is scored according to a ratio of common dishes by comparing the kinds of dishes of the selected shop and those of the other shops stored in the shop DB. For example, it is scored such that coincidence of the kinds of dishes to be offered becomes higher such as five points, three points, and one point when not lower than 90%, 70%, and 50% of the dishes of the selected shop are covered, respectively, to calculate the approximation degree.

Meanwhile, the dishes include not only foods but also beverages; as for the beverages, a target for comparison is not only the same kind of beverages but also the beverages of the same mark.

3-7. Compared Element (Shop Customer Layer)

The approximation degree of (7) shop customer layer is calculated by the information of the shop customer layer stored in the shop DB 242 and the parameter for scoring the approximation degree of the shop customer layer stored in the evaluation criterion DB 245.

Specifically, when the elements such as age, sex, address, and occupation of the customer who uses the shop are common between the selected shop and other shops stored in the shop DB, the point is added. For example, if the selected shop is frequently used by people in their thirties, one point is added to the shop frequently used by the people in their thirties to calculate the approximation degree.

### 4. Information Distributing Process

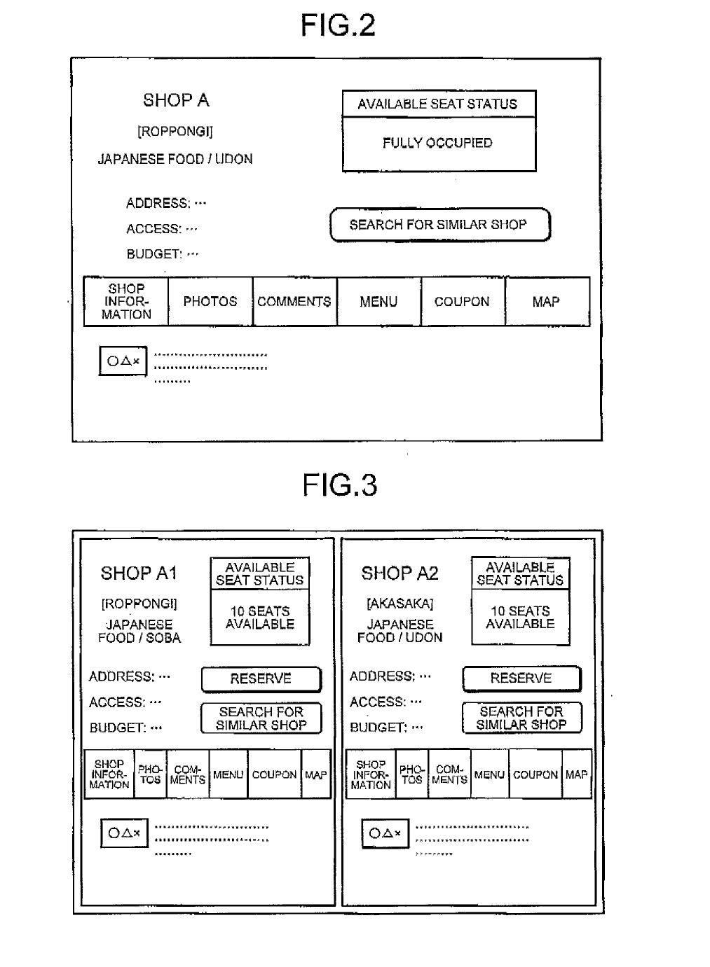

An information distributing process of this embodiment is described with reference to FIGS. 2 to 5.

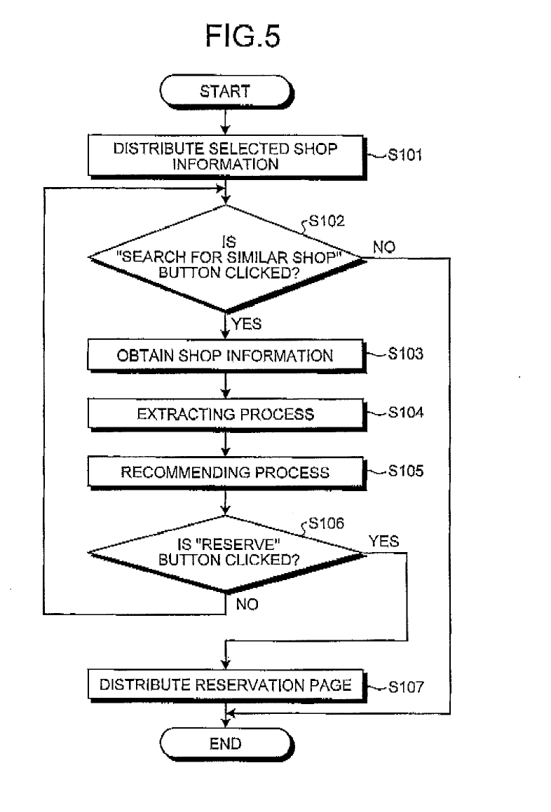

The information distributing process is executed under control of the control unit 21 of the information processing device 20 at each step (FIG. 5). The process is started when the user receives the pieces of information of a plurality of shops while specifying the search condition, selects one shop (selected shop) from the plurality of shops, and performs click operation and the like to display a shop information page of the selected shop on the restaurant search site on the Internet, for example.

First, the control unit 21 of the information processing device 20 receives a shop information obtaining request of the selected shop from the terminal device 10. Then, the information processing device reads the selected shop information to be displayed as the web page from the page DB 241, the shop DB 242, and the available seat DB 243 to distribute to the terminal device 10 (step S101).

Meanwhile, the selected shop information includes the available seat information of the shop, and “search for similar shop” button information for searching for the similar shop.

Next, the terminal device 10 receives the selected shop information and displays the shop information page of the selected shop on the display unit 13. The selected shop information includes the available seat information of the shop in addition to the information such as the shop name, the shop location, the food category, the shop address, access to the shop, the budget, photos of the shop, comments, menu, a coupon, and a map; if the shop selected by the usr is fully occupied, it is displayed as “fully occupied” (FIG. 2).

The “search similar shop” button for searching for the similar shop is displayed under the available seat information.

When the “search for similar shop” button is clicked by the user, the control unit 11 of the terminal device 10 transmits the information to the information processing device 20.

The control unit 21 of the information processing device 20 determines whether the “search for similar shop” button is clicked (step S102). When the “search for similar shop” button is clicked (YES at step S102), the procedure shifts to a nest process (step S103), and otherwise (NO at step S102), the procedure is finished.

Meanwhile, the control unit 11 determines (step S102) while the selected shop information page is displayed on the display unit 13 of the terminal device 10, and if the user performs transition operation of the web page, browsing finishing operation or the like, the procedure is finished supposing that the button is not clicked (NO at step S102).

Next, at step S103, the control unit 21 obtains the information of the selected shop from the shop DB 242. Meanwhile, the information of the selected shop to be obtained is not limited to the information of the selected shop distributed at step S101, and the information of various items for calculating the approximation degree is obtained.

Next, the control unit 21 extracts the recommended shops satisfying a predetermined approximation condition based on the shop information of the selected shop and the shop information of other shops stored in the shop DB 242 (step S104).

Specifically, for example, the approximation degree is scored based on the evaluation criterion DB 245 for the compared elements of (1) distance from selected shop, (2) price range, (3) food category, (4) facility name, (5) area of food category, (6) kinds of dishes to be offered, and (7) shop customer layer, for comparing the pieces of shop information for each item stored in the shop DB 242, and the shop with the high approximation degree is extracted as the recommended shops.

Meanwhile, when the recommended shops are extracted, the available seat information of the shop is also obtained from the available seat DB 243 and extracted from the shops with the available seats.

Next, the control unit 21 recommends two shops in descending order of approximation degree from the recommended shops and distributes the shop information to the terminal device 10 (step S105). Then, the control unit 11 of the terminal device 10 displays the shop information on the display unit 13.

Specifically, when two shops (shops A1 and A2) are recommended in descending order of approximation degree from the recommended shops, for example, two pieces of shop information of the shop A1 and the shop A2 are displayed in parallel on the display unit 13 of the terminal device 10 (FIG. 3).

Meanwhile, the displayed web page includes a “reserve” button for reserving the recommended shop and the “search for similar shop” button for further searching the shop similar to the recommended chop.

When the “reserve” button is clicked for the shop selected by the user (second selected shop) out of the two recommended shops which are recommended, the control unit 11 of the terminal device 10 transmits information to the information processing device 20.

The control unit 21 of the information processing device 20 determines whether the “reserve” button is clicked (step S106). When the “reserve” button is clicked (YES at step S106), the procedure shifts to a next process (step S107), and otherwise (NO at step S106), the procedure returns to step S102.

When the procedure returns to step S102, if the “search for similar shop” button is clicked for the stop selected by the user (second selected shop) out of the two recommended shops which are recommended, a shop similar to the second selected shop is extracted as the recommended shop in a subsequent extracting process (step S104).

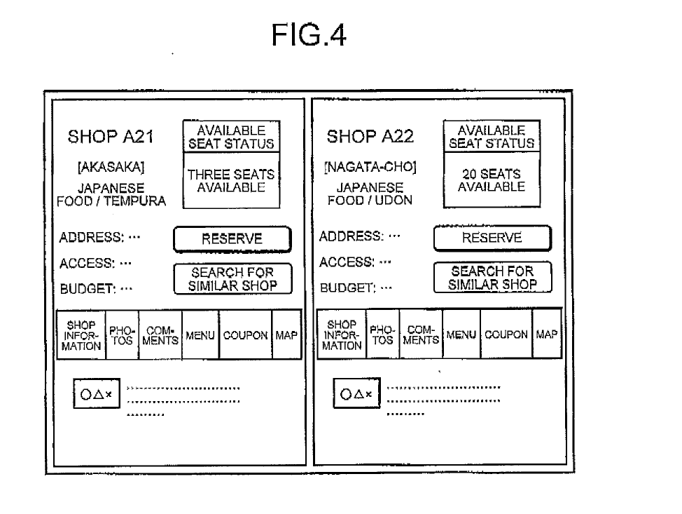

Herein, if the shop A2 is selected as the second selected shop at step 3102 (FIG. 3), the control unit 21 recommends a shop A21 and a shop A22 in a recommending process (step S105), for example, to transmit to the terminal device 10. Then, the control unit 11 of the terminal device 10 displays the shop information of the shop A21 and that of the shop A22 on the display unit 13 (FIG. 4).

At step S107, the control unit 21 reads required information for displaying the web page for reserving from the page DB 241 and the shop DB 242 for the recommended shop the “reserve” button of which is clicked, distributes the same to the terminal device (step S107), and finishes the procedure.

### 5. Another Embodiment

Next, another embodiment is described.

Although a case in which a selected shop selected on a restaurant search site is fully occupied is described in an information distributing process of this embodiment, it may also be configured such that a shop similar to the selected shop may be searched for not only when the selected shop is fully occupied but also when it is displayed that there is an available seat.

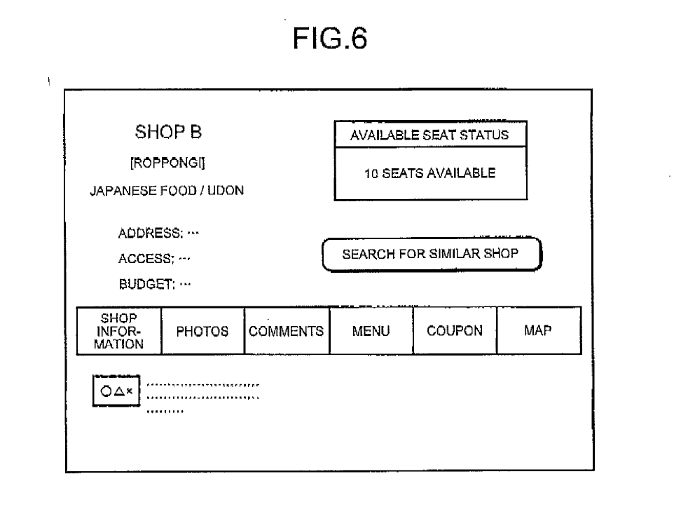

Specifically, even in a case in which it is displayed that there is the available seat in a shop information page of the selected shop as illustrated in FIG. 6, for example, a “search for similar shop” button may be displayed such that information processing illustrated in FIG. 5 is executed.

In this manner, the embodiment may be configured to perform the information processing regardless of a result of available seat information and this may be formed without an available seat DB 243.

### 6. Conclusion

As described above, in the embodiment, when the user searches for the information of the shop such as the restaurant on the Internet, if the selected shop which the user first selects is fully occupied and the user clicks the “search for similar shop” button, the information processing device may extract the recommended shop with the high approximation degree to the selected shop and meeting a user's wish to recommend to the user.

Since the recommended shop is distributed only by the simple operation to click the “search for similar shop” button, even when the selected shop cannot be used because this is fully occupied and the like, for example, it is not required to return to a search screen to select again from the large number of shops, and search time is significantly shortened.

It is also possible to recommend the recommended shop similar to the second selected shop by selecting one shop (second selected shop) from the predetermined number of recommend shops which are recommended and further clicking the “search for similar shop” button.

In the embodiment, it is possible to repeatedly select while comparing pieces of specific shop information to recommend the shop meeting the user's wish in this manner.

The condition wished by the user is often unclear at the time of search and it is not always true that the specified condition at the time of search fully meets the user's wish; however, it is possible to find out user's potential demand which is not clear at the time of search by repeatedly selecting by clicking the “search for similar shop” button of the embodiment.

### 7. Others

For example, although an example in which “fully occupied”, “10 seats available” and the like are displayed is described as a simplified example of the display of the available seat status in FIGS. 2 to 4 and 6, the available seat status may also be displayed in detail. Specifically, the available seat status may be more specifically displayed such as “two tables for four” and “one private room for 10”.

It is also possible that the control unit 21 is provided with a searching unit with which it is possible to select a condition whether the seats may be separated within the shop or whether the customers may be guided to different shops when clicking the “search for similar shop” button.

In such a configuration, it is possible to search according to the circumstances of the user even when the number of customers is large and it is difficult to find out the shop in which all the customers may be seated next to one another, for example.

Although the search condition initially set by the user is utilized for weighting in the calculation of the approximation degree in this embodiment, when the recommended shops similar to the selected shop are recommended and the user selects the shop (second selected shop) from the recommended shops which are recommended, it is possible to weight the compared element which is the same between the selected shop and the second selected shop.

Specifically, suppose that, when a restaurant is searched for, far example, if “shop A of udon in Roppongi (selected shop)” is fully occupied (refer to FIG. 2) and “shop A1 of soba in Roppongi” and “shop A2 of udon in Akasaka” are recommended as the recommended shops similar to the shop A (refer to FIG. 3), then the user selects the shop A2 (second selected shop). In this case, when the compared elements are compared between the “shop A of udon in Roppongi (selected shop)” and the “shop A2 of udon in Akasaka (second selected shop)”, the food category of “udon” is the same, so that the food category may be weighed.

Although an example in which the food category is the same is described above, in a case of other compared elements (for example, distance from shop), it is possible to store the evaluation criterion for determining whether the compared element is the same in the evaluation criterion DB 245 to determine whether this is the same based on the evaluation criterion.

At the time of weighting, this may be used not only for the weighting simply for the user who is selecting but also for the weighting for other people.

Specifically, it is possible to use by generalizing for each user's attribute by analyzing a trend of many people to obtain the compared element on which men in their twenties place importance, and the compared element on which many of the people who select the shop A place importance.

Furthermore, it is possible to weight in an appropriate manner other than the above, and it is possible to weight by allowing the user to explicitly select the compared element on which the user places importance when searching for the similar shop, for example.

In the embodiment, it may also be configured such that a preferred shop of the user may be set as a favorite such that the similar shop may be searched for by a separately set condition such as the location for the shop.

Specifically, when the user registers a shop near Tokyo station as the preferred shop, for example, it is also possible to search for a shop similar to the preferred shop by specifying an area within 100 m from Osaka station.

In this manner, if the user wants to search for the shop meeting the user's preference in the place in which the user visits for the first time, it is possible to easily search for the shop similar to the preferred shop registered as the favorite and easily search for the shop meeting the user's wish. It is not required to set a complicated search condition, so that the search time is significantly shortened.

Although the two shops are recommended in descending order of approximation degree from the recommended shops and two pieces of shop information are displayed on the display unit 13 of the terminal device 10 in parallel in the embodiment (refer to FIG. 3), the number of shops to be displayed may be appropriately changed and four shops may be displayed, for example, in a vertically and horizontally arranged manner. If the number of options is increased in this manner, probability that the shop meeting the user's wish more is displayed becomes higher.

Although the approximation degree is scored to be compared when the approximation degree is calculated in the embodiment, it is also possible to obtain the approximation degree by ranking the criteria for evaluating to A, B, C and the like, for example, in the evaluation criterion DB 245 and counting the number of A ranks.

Although the information is distributed by display of the shop similar to the selected shop on the web page as the recommended shop in the embodiment, this is not limited to this embodiment and this may be applied to various services such as distribution of the information of the recommended shop by e-mail.

Although it transits to the screen for reserving by clicking the “reserve” button in the embodiment, this is not limited to this embodiment and a phone number may be simply displayed.

Although an example in which the process is executed by click operation of the button displayed on the web page is described as an example in the embodiment, the embodiment may also be naturally applied to the terminal device 10 including the touch panel such as the smartphone and the tablet computer, and in this case, the process is executed by touch operation such as tap operation and other selecting operation.

Furthermore, the scope of the embodiment is not limited to the above and various modifications and design changes may be made without departing from the gist of the embodiment.

According to the present invention, it is possible to distribute the information with a high level of satisfaction meeting the user's wish by simple operation when the user searches for the shop on the Internet.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
a storage unit configured to store shop information regarding a predetermined item for each shop;
an extracting unit configured to extract a recommended shop satisfying a predetermined approximation condition based on the shop information of a selected shop selected by a user and the shop information of a shop other than the selected shop stored in the storage unit; and
a recommending unit configured to recommend the recommended shop extracted by the extracting unit to the user.

2. The information processing device according to claim 1, wherein
the shop information includes available seat information of the shop, and
the extracting unit extracts the recommended shop from shops with an available seat when the selected shop is fully occupied.

3. The information processing device according to claim 1, wherein
the extracting unit calculates an approximation degree of a compared element obtained by comparing pieces of shop information for each predetermined item, and extracts the recommended shop based on the calculated approximation degree of the compared element, and
the recommending unit recommends the predetermined number of recommended shops to the user in descending order of approximation degree.

4. The information processing device according to claim 3, wherein the compared element includes at least one of distance from the selected shop, a price range, a food category, a shop name, an area of food category, kinds of dishes to be offered, and a shop customer layer.

5. The information processing device according to claim 4, wherein the extracting unit calculates the approximation degree by weighting each compared element.

6. The information processing device according to claim wherein the extracting unit weights the compared element the same between a second selected shop selected by the user from the recommended shops recommended to the user and the selected shop.

7. The information processing device according to claim 1, wherein the extracting unit extracts a recommended shop satisfying a predetermined approximation condition again based on the shop information of the second selected shop selected by the user from the recommended shops recommended to the user and the shop information of a shop other than the selected shop and the second selected shop stored in the storage unit.

8. The information processing device according to claim 1, comprising:
a searching unit configured to select at least one of search conditions of whether seats may be separated within the shop or whether customers may be guided to different shops by the user, wherein
the extracting unit extracts, when at least one of the search conditions of whether the seats may be separated within the shop or whether the customers may be guided to different shops is selected by the user, the recommended shop satisfying the search condition.

9. An information processing method performed by an information processing device, the information processing method comprising:
extracting a recommended shop satisfying a predetermined approximation condition based on shop information of a selected shop selected by a user and shop information of a shop other than the selected shop stored in a storage unit which stores the shop information regarding a predetermined item for each shop; and
recommending the recommended shop extracted by the extracting unit to the user.

10. A non-transitory computer-readable storage medium with an executable program stored thereon, wherein the program instructs a computer to perform:
extracting a recommended shop satisfying a predetermined approximation condition based on shop information of a selected shop selected by a user and shop information of a shop other than the selected shop stored in a storage unit which stores the shop information regarding a predetermined item for each shop; and
recommending the recommended shop extracted by the extracting unit to the user.
